(19) United States
(12) Patent Application Publication
(10) Pub. No.: US 2018/0029041 A1
(43) Pub. Date: Feb. 1, 2018

(54) Improved Apparatus for Disintegration of a Solid and Method

(71) Applicant: Liquitab Systems Limited, Mentone (AU)

(72) Inventors: David John Bull, Lane Cove (AU); Julian Meyer, Elamora Heights (AU)

(73) Assignee: Liquitab Systems Limited, Mentone (AU)

(21) Appl. No.: 15/552,816

(22) PCT Filed: Feb. 10, 2016
(86) PCT No.: PCT/US2016/050079

§ 371 Date: Aug. 23, 2017

(30) Foreign Application Priority Data
Feb. 24, 2015 (AU) 2015900647

(51) Int. Cl. B02C 19/18; A61J 7/00; B02C 23/36

(52) U.S. Cl. CPC B02C 19/18; B02C 23/36; A61J 7/0046

(57) ABSTRACT

An apparatus for disintegration (or mixing) of a solid in a vessel containing liquid, has a control unit and an ultrasound transducer for generating ultrasonic energy under control of the control unit. A coupling medium in communication with the ultrasound transducer is adapted to receive the vessel. Ultrasonic energy is transferred to the contents of the vessel such that in use the ultrasonic energy causes disintegration of the solid into the liquid contained in the vessel. An agitating mechanism is adapted to agitate the disintegrated solid in the liquid contained in the vessel. The agitating mechanism may include a paddle having a coating of flavouring material. A method for disintegration of a solid in a vessel is also disclosed.

### CROSS REFERENCE TO RELATED APPLICATIONS

The present invention is related to the following patent applications, the disclosures of which are incorporated herein by cross reference.
AU 2013204792 entitled APPARATUS METHOD AND SYSTEM FOR DISINTEGRATION OF A SOLID
PCT/AU2013/001147 entitled APPARATUS METHOD AND SYSTEM FOR DISINTEGRATION OF A SOLID

### FIELD OF THE INVENTION

The present invention relates to improved apparatus for disintegration or dispersion of a solid in liquid using ultrasound energy and/or a method for the same. It relates particularly but not exclusively to disintegration of a solid being a pharmaceutical composition or medication in the form of a tablet, pill, capsule, caplet or the like for dissolving, dispersing, suspending, emulsifying and/or otherwise working into a fluid for consumption by drinking.

### BACKGROUND TO THE INVENTION

A preferred method for administering medication orally is by consumption of a solid form of medication such as a tablet, pill, capsule, caplet or the like. Providing medication in tablet form utilises inexpensive production techniques, cheaper packaging and provides a relatively long shelf life for the medication. A further advantage is that each tablet may contain a known dosage of the medication which may be dispensed in unitary fashion from a bottle, blister pack or other packaging immediately prior to consumption. Where tablets are contained in a blister pack, unitary dispensing of each tablet dosage may prevent oxidation and/or contamination of the remaining dosages. In contrast, liquid formulations may have a relatively short shelf life and each dose may require individual measuring.

There are, however, problems associated with administering medication in tablet form. A large proportion of the population experiences difficulty swallowing tablets. This syndrome is known as dysphagia and is associated with taking certain forms of oral medication, particularly tablets. In some cases, tablets may be particularly large and difficult to swallow. For many patients, swallowing tablets may elicit a gag reflex. Other patients such as the mentally ill, the elderly and small children may be unable to swallow solid medication. This problem may also be experienced by patients who are unconscious and/or patients who use a feeding tube.

Historically, problems associated with swallowing whole tablets have been addressed by mechanical crushing of a solid medication. There are various ways to perform mechanical crushing of medication in solid form. One approach may involve use of a mortar and pestle to break up the tablet for dissolution or suspension in a liquid. Other approaches may involve placing the tablet inside a plastic envelope or sheath and hammering the sheath to break the tablet into small particles. These particles are then collected and worked into jam or other food to be consumed by the patient.

Drawbacks of these methods include inconsistent particle size and a risk of cross-contamination between medications. Although the devices may be cleaned between uses, this may add considerably to the time required to prepare and administer the medication and there may be a risk that cleaning may not be performed as regularly or as thoroughly as needed. Furthermore, there may be a risk that a recipient may receive a medication dosage which is less than an entire tablet, since residual tablet particles may be left behind in a crushing device. In addition, nurses and carers operating mechanical crushing devices may become exposed to the medication when in powdered form by inhaling or physical contact which may have health implications.

In view of these drawbacks, it would be desirable to provide an alternate approach for disintegrating medication in solid form for consumption, e.g. in a liquid.

A reference herein to a patent document or other matter which is given as prior art is not to be taken as an admission that that document or matter was known or that the information it contains was part of the common general knowledge as at the priority date of any of the claims.

Throughout the description and claims of the specification, the word “comprise” and variations of the word, such as “comprising” and “comprises”, is not intended to exclude other additives, components, integers or steps.

### SUMMARY OF THE INVENTION

Viewed from one aspect, the present invention provides an apparatus for disintegration of a solid in a vessel containing liquid, the apparatus comprising: a control unit; an ultrasound transducer for generating ultrasonic energy under control of the control unit; a coupling medium in communication with the ultrasound transducer and adapted to receive the vessel and through which ultrasonic energy is transferred to the contents of the vessel such that in use the ultrasonic energy causes disintegration of the solid into the liquid contained in the vessel; and an agitating mechanism adapted to agitate the disintegrated solid in the liquid contained in the vessel.

The agitating mechanism may include a paddle having a coating of a flavouring material. The coating material may include neutral gelatine, flavouring concentrate and/or artificial sweetener.

The apparatus may include a cover member for closing an opening in the vessel, wherein the cover member includes the agitating mechanism. The cover member may include a force actuator adapted to apply a force to the vessel to enhance coupling between the vessel and the coupling medium. The cover member may be operable from an open configuration to a closed configuration in two or more stages to maintain alignment with the vessel.

The apparatus may include means to detect dissolution of the paddle coating material. The means to detect dissolution of the paddle coating material may include at least one of an optical means, an electrical conductivity means and a fudicial marker.

The apparatus may include means to detect presence of the paddle in the agitating mechanism. The means to detect presence of the paddle may include at least one of a micro-switch associated with the agitating mechanism, means for monitoring current drawn by an associated drive motor and means for monitoring a break in an optical beam.

The coupling medium may include a water bath. The apparatus may include means for maintaining a predetermined level of the coupling medium. The ultrasound transducer may communicate ultrasonic power to the coupling medium by way of an ultrasound waveguide or the like.

The control unit may control the ultrasound transducer to operate in a swept frequency mode in which ultrasonic energy frequency fluctuates between a resonant frequency and a first non-resonant frequency and optionally, a second non-resonant frequency.

The resonant frequency may be substantially 42 kHz and the first and second non-resonant frequencies may be substantially ±2 kHz relative to the resonant frequency.

The swept frequency mode may be one or more of: cyclical; random; and dynamically controlled by the control unit based one or more sensor inputs. The apparatus may include cooling means for maintaining temperature of the apparatus and/or the contents of the vessel in an acceptable range during operation of the apparatus. The vessel may include a marking to indicate a fill level for a liquid added to the vessel.

Another aspect of the invention provides a method for disintegrating a solid in a vessel including the steps of providing a volume of liquid together with the solid in the vessel; providing an ultrasound transducer for generating ultrasonic energy; loading the vessel containing the solid and liquid into a coupling medium in communication with the ultrasound transducer; transferring the ultrasonic energy to the contents of the vessel to cause disintegration of the solid into the liquid contained in the vessel; and agitating the disintegrated solid in the liquid contained in the vessel.

### BRIEF DESCRIPTION OF THE DRAWINGS

Preferred embodiments of the present invention will now be described with reference to the accompanying drawings. It is to be understood that the embodiments illustrated are provided by way of example only. The particularity of these embodiments does not supersede the generality of the preceding parts of the description. In the drawings:

FIG. 1 shows apparatus according to one embodiment of the present invention;

FIG. 2 shows a graph of an ultrasonic energy signal in swept mode, according to one embodiment of the invention;

FIG. 3a shows a flow diagram including steps of a method of disintegrating a solid form of medication according to one embodiment of the present invention;

FIG. 3b shows a flow diagram including steps of a method of disintegrating a solid form of medication according to another embodiment of the invention;

FIG. 3c shows a flow diagram including further steps which may precede the method steps outlined in FIGS. 3a and 3b;

FIGS. 4a shows a side view of a receptacle securing device;

FIGS. 4b and 4c show side and perspective views of a receptacle securing device with mechanical stirrer;

FIG. 5 shows apparatus according to another embodiment of the present invention including a mechanical stirring mechanism;

FIG. 6 shows detection of dissolution of a drug tablet;

FIG. 7 shows detection of dissolution of a flavouring paddle coating by means of electrical conductivity;

FIG. 8 shows a fudicial marker applied to a paddle;

FIG. 9 shows detection of dissolution of a paddle coating by optical means; and

FIG. 10 shows a method of regulating level of a water bath.

### DETAILED DESCRIPTION

Throughout this description, the terms “tablet” and “drug tablet” will be used to describe any solid form of medication or pharmaceutical preparation provided in tablet, pill, capsule, caplet or other such like form which is amenable to disintegration. Although some such tablets have coatings or layered formulations for slow release of active constituents, the method and apparatus of the present invention may still be useful for disintegration of the tablet into a form which can be dispersed, suspended, dissolved, emulsified or otherwise combined into a liquid for oral consumption.

Although the apparatus and method are described herein in the context of disintegration of a solid form of medicament, it is to be understood that the present invention and the claims appended hereto are not so limited. The present invention has applicability to disintegration of non-medicament solids and/or mixing of liquids and or solids/particles in a liquid.

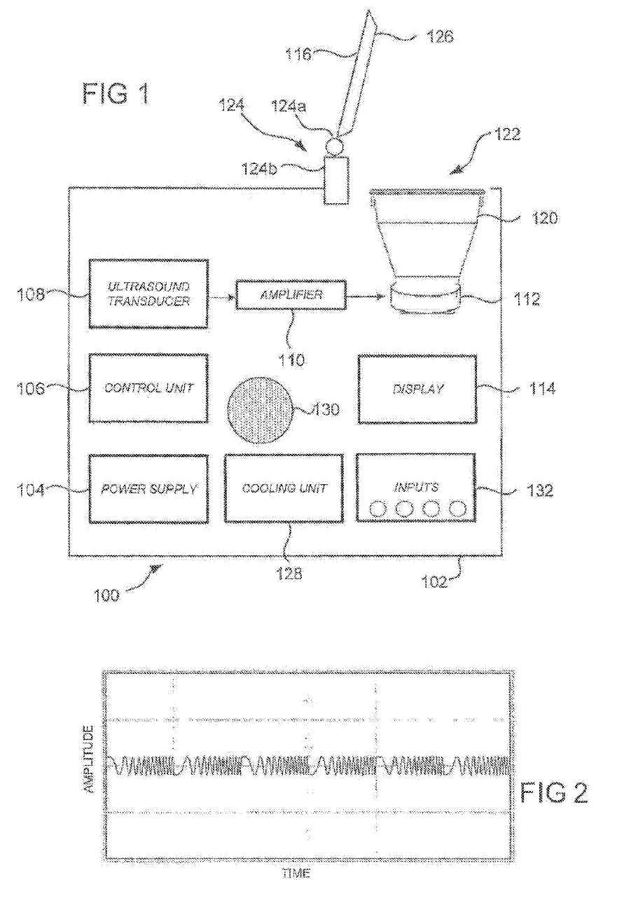

Referring to FIG. 1 there is shown apparatus 100 for disintegration of a solid, such as solid medication in the form of a tablet, according to an embodiment of the present invention. Apparatus 100 includes housing 102 which is preferably manufactured from durable plastics or other material which can be wiped with a cloth and which can be manufactured and shipped in a cost effective manner. Although housing 102 has little involvement with functionality of apparatus 100 (other than a cover member as discussed below), it is desirable that housing 102 be designed with usability in mind. Thus it may be desirable that housing 102 has attractive appearance akin to a household appliance, rather than a device used in a medical setting.

Housing 102 includes opening 122 into which drug vessel 120 containing a tablet and liquid may be received. A cover member 116 is provided to close opening 122 during use so that drug vessel 120 is not inadvertently removed before disintegration is completed and/or to avoid accidental spillage or contamination. Drug vessel 120 may be fitted with a sealing lid prior to being inserted into apparatus 100 to limit risk of liquid being spilled from inside drug vessel 120 and concomitant loss of medication. After the tablet has been disintegrated, drug vessel 120 may be removed from apparatus 100, the sealing lid may be removed from drug vessel 120 and the contents, which include the disintegrated drug tablet, may be consumed by drinking.

Housing 102 includes power supply 104 and control unit 106. Power supply 104 may be coupled to an external AC power source and may regulate power to provide voltage as needed to control unit 106, ultrasonic transducer 108, display 114 and other powered components in apparatus 100. Preferably, power supply 104 includes an auto-regulating supply to minimize power required to maintain ultrasonic vibrations generated by transducer 108 at an amplitude specified by control unit 106.

Control unit 106 is operably coupled to ultrasound transducer 108 and other components such as display 114 and actuator 124 for cover member 116, each of which may be controlled by an electronic signal. Control unit 106 comprises control electronics preferably embodied in firmware written to read only memory (ROM) or programmable ROM (PROM) of a microprocessor as is known in the art, although it is to be understood that control electronics may alternatively be provided on a standalone computer or other memory-processor device operably connected to apparatus 100 and its components.

Ultrasound transducer 108 generates ultrasonic energy under control of control unit 106 and is coupled to coupling element or sonotrode 112 via amplifier 110. Amplifier 110 amplifies the ultrasound signal from transducer 108 to an intensity sufficient to cause disintegration of a tablet in drug vessel 120 within a reasonable time frame.

Amplification may be by a factor of e.g. 10 or more where a low intensity ultrasound signal is emitted from transducer 108. Preferably, acousto-mechanical amplification required may be less than ×10, and more preferably, less than x 5 so that amplifier 110, whose geometry may be dictated by the amount of amplification, may be accommodated in apparatus 100 for use on a bench top or trolley. For a standard 50 W transducer, an amplification factor of about 3 has been found sufficient as this may give rise to disintegration times of less than about 6 minutes for a range of different tablet types. Preferably, the time required to achieve disintegration is less than 10 minutes and more preferably less than 6 minutes. A disintegration time of about 3 to 6 minutes may be acceptable in many settings although a disintegration time of one minute or less may be desirable e.g. for high throughput apparatus. Shorter disintegration times may be achieved by using a higher intensity/higher amplitude ultrasound signal.

Ultrasound transducer 108 may be of any suitable type although a piezoelectric transducer is preferred, having a resonant frequency greater than 20 kHz which is accepted to be an upper limit of human hearing. In one embodiment, ultrasound transducer 108 may have a resonant frequency of about 40 kHz although such frequency is not to be taken as prescriptive and transducers having different operational ranges may be utilised while the design of other components such as amplifier 110 and sonotrode 112 may be modified to achieve tablet disintegration in a desired time.

Resonant frequencies in a range 20-45 kHz may be used. However, as resonant frequency approaches a lower limit of this range, likelihood of human awareness of the ultrasonic signal may increase. Thus, use of apparatus 100 at lower frequencies may cause irritation to persons in the vicinity of apparatus 100 when in use. In addition, in a preferred embodiment sonotrode 112 may have a circumference equivalent to about one wavelength of energy generated by ultrasound transducer 108 at resonance. Since wavelength is inversely proportional to frequency, decreasing resonant frequency may increase the diameter of sonotrode 112 for a given sonotrode material.

Sonotrode 112 may be configured to receive drug vessel 120 containing the solid to be disintegrated. Ultrasonic energy may be coupled, through sonotrode 112 and wall of drug vessel 120, to the contents. Since drug vessel 120 may sit inside sonotrode 112 to achieve this coupling, a relatively large sonotrode diameter may require a drug vessel 120 such as a cup that may be too large for many users to handle. Moreover, an overly large sonotrode 112 may in turn require an unacceptably large apparatus 100 which may limit appeal to end users.

Conversely, increasing ultrasound frequency may produce a decrease in diameter of sonotrode 112 which may, in turn, require a decrease in diameter of drug vessel 120 at least at a region which fits into and couples with sonotrode 112. This may have implications for receptacle usability eg. (a cup which is too small can be just as difficult to handle and drink from as a cup which is too large) and also for receiving an acceptable volume of liquid. Thus, embodiments of the present invention may adopt a trade-off wherein a readily available ultrasound transducer able to produce a resonant frequency of about 42 kHz may be selected.

Alternatively or additionally, ultrasound transducer 108 may be amenable to operating at a range of frequencies, and the operating frequency may be controlled by control unit 106, based on resonant frequency of apparatus 100 including drug vessel 120 and its contents when placed in sonotrode 112. Control unit 106 may determine automatically an optimal frequency for disintegration of a solid within drug vessel 120, and may control ultrasound transducer 108 to generate ultrasonic energy at an optimal frequency. Such an arrangement may include feedback control electronics which may monitor e.g. current being drawn as an indicator of whether or not apparatus 100 is operating at resonance. Other methods for determining resonance of apparatus 100 and/or matching operating frequency of ultrasound transducer 108 may be utilised, as may be understood by persons of ordinary skill in the art.

In one embodiment, ultrasound transducer 108 may operates in a simple mode, generating energy at about a resonant frequency. The ultrasonic signal may be coupled, through amplifier 110 and sonotrode 112, to drug vessel 120 and its contents comprising one or more medication tablets together with a liquid such as water. Unless the particles in the drug tablet are held together very firmly they will tend to separate due the immense accelerations generated by high pressure changes caused by ultrasonic vibrations.

During testing of the apparatus of the present invention, it has been discovered that particulate matter which forms as the drug tablet disintegrates may group together inside the drug vessel 120, most notably in the crease where the wall of vessel 120 meets the floor. This is undesirable since reflective and diffractive losses may occur thereby limiting efficiency of continued ultrasonic treatment by apparatus 100. Furthermore, when the disintegration process is complete it can become difficult to dislodge particles from the drug vessel 120 when the contents are consumed orally.

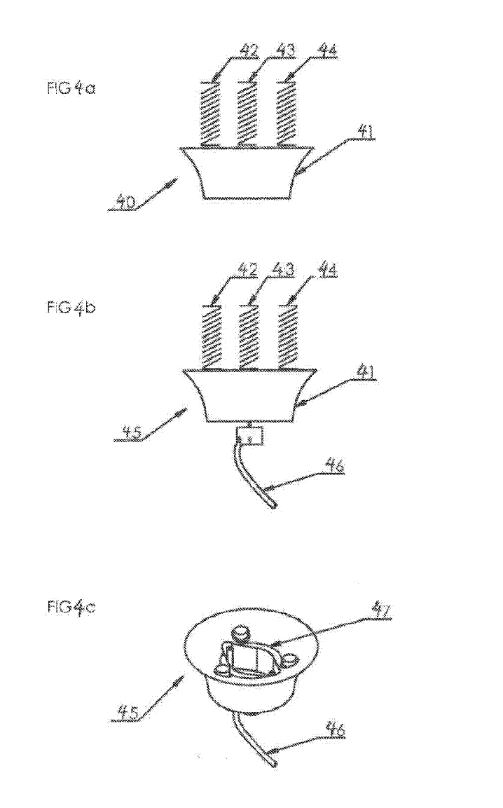

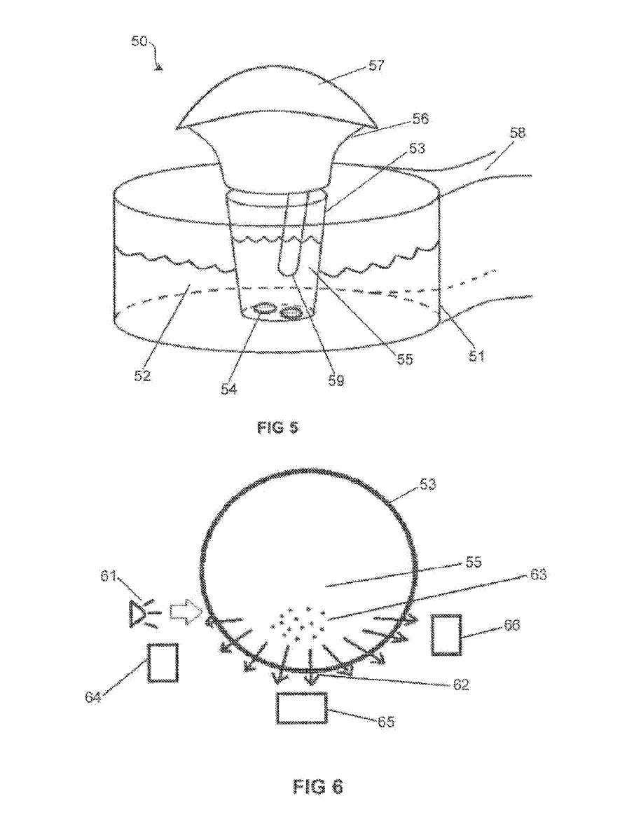

To address this problem, it may desirable to agitate the contents of drug vessel 120 such that they become properly dispersed within the liquid or at least removed from the crease area. Agitation may be provided in any suitable manner and by any suitable means. In one embodiment a mechanical agitator may be associated with cover member 116. The mechanical agitator may include a steel hook driven via a stepper motor as shown in FIGS. 4b and 6c and/or a stirring mechanism as shown in FIG. 5.

In another embodiment, agitation of contents of drug vessel 120 may be achieved by operating ultrasound transducer 108 in a swept frequency mode. FIG. 2 shows a graph representing a driving signal as may be applied to ultrasound transducer 108 in swept frequency mode, according to an embodiment of the present invention. In swept frequency mode the signal driving ultrasound transducer 108 and hence the ultrasonic energy emitted from transducer 108, fluctuates between a resonant frequency and a non-resonant frequency. In one embodiment, swept frequency mode operation may involve fluctuations between the resonant frequency and a non-resonant frequency either side of the resonant frequency. The non-resonant resonant frequency may be e.g. ±0.1%, ±0.5%, ±1%, ±2%, ±3%, ±5% or even ±10% of the resonant frequency. Experimental data suggests that for a transducer resonant frequency of about 42 kHz, the non-resonant end point frequencies employed in swept frequency mode may be approximately 5% or 2 kHz either side of the resonant frequency such that the ultrasonic frequency signal emitted by transducer 108 oscillates between about 40 kHz and 44 kHz.

During swept frequency operation, control unit 106 controls the frequency applied to ultrasound transducer 108 to increase and decrease around the resonant frequency. Sweeping of frequencies may occur at any rate. In one embodiment, the sweep cycle may be approximately 0.3 to 2 Hz such that frequency sweeps between resonance and a predetermined non-resonant frequency every 0.5 seconds to every 2 or 3 seconds, although longer or shorter sweep cycles may be implemented. Frequency sweeping may be cyclical or random, and/or may be adjusted dynamically and preferably automatically by control unit 106 according sensor inputs providing feedback to control unit 106 indicating the extent to which particles disintegrated from a solid may require further agitation within drug vessel 120.

As the drive signal frequency approaches the resonant frequency, the amplitude of ultrasound vibrations may increase. At the resonant frequency, apparatus 100 may apply maximum amplitude ultrasonic vibrations to drug vessel 120. As the drive signal frequency is further increased, apparatus 100 may move past its resonance point and the amplitude of ultrasound vibrations may decrease.

Control unit 106 may be configured with a predetermined upper limit (e.g. the maximum frequency) for a drive signal. Once the frequency of the drive signal reaches a predetermined upper limit, control unit 106 may begin to decrease the frequency. As the decreasing frequency approaches the resonant frequency the amplitude of ultrasound vibrations will again increase until apparatus 100 is operating in resonance mode.

Preferably, control unit 106 further decreases the frequency of the drive signal. As the frequency of the drive signal is decreased below resonance, the amplitude of ultrasound vibrations may decrease again. Control unit 106 may be configured with a predetermined lower limit (i.e. minimum operational frequency) for a drive signal. Once the frequency of the drive signal reaches a predetermined lower limit control unit 106 may begin to increase the frequency. As the increasing frequency approaches the resonant frequency, the amplitude of ultrasound vibrations may again increase until apparatus 100 is operating in resonance mode. Sweeping the frequencies between resonance and one or more predefined non-resonance frequencies may continue.

Operating apparatus 100 in swept frequency mode may agitate the contents of drug vessel 120 and decreases the extent to which disintegrated particles group together in the drug vessel. This may improve efficiency with which the solid is disintegrated.

Preferably, apparatus 100 includes a force actuator 126 which applies force to drug vessel 120 when loaded in sonotrode 112 to enhance coupling between sonotrode 112 and a wall of drug vessel 120. This may maximise transference of ultrasonic energy to the contents of drug vessel 120. In the embodiment illustrated in FIG. 1, force actuator 124 is contained within cover member 116 for closing opening 122 in housing 102 although any actuator suitable for applying a coupling force between drug vessel 120 and sonotrode 112 may be utilised.

In the illustrated arrangement, force actuator 124 may include an internally sprung membrane suitable for applying a downward force of approximately 800 to 1,000 grams through vessel 120 when cover member 116 is in a closed position. Force actuator 124 may limit the extent to which vessel 120 hovers or moves within sonotrode 112 during operation. Applying a greater downward force into sonotrode 112 may improve coupling (i.e. energy transfer into vessel 120) until damping occurs. A downward force greater than 1,000 g may be used to improve coupling although this may negatively impact overall design. For example, in the case of downward forces greater than about 1000 grams in embodiments where a mechanical (e.g. spring loaded) actuator is used to release cover member 116, design and operation may become complex.

Preferably, cover member 116 including force actuator 124 may be operable from an open configuration (FIG. 1) to a closed configuration (not shown) in two stages to maintain alignment of vessel 120 within sonotrode 112 particularly during application of a coupling force. In one embodiment, cover member 116 may utilise a two-stage actuator 124 during closure. In one stage, cover member 116 may pivot around hinge 124a; in another stage, cover member 116 may be lowered into opening 122 via vertical actuator 124b. Vertical actuator 124b may be provided by resilient, pneumatic, hydraulic, electronic and/or other means and may operate manually via mechanical means or automatically, under control of control unit 106 to open and close cover member 116.

It is to be understood that a range of different closure arrangements may be provided which facilitate closure of opening 122 while maintaining alignment of vessel 120 within sonotrode 112. One arrangement may include a securing device for vessel 120 as shown in FIG. 4a including a flared body adapted to be received in the mouth of vessel 120. The flared body may provide better lateral alignment of vessel 120 within sonotrode 112. The flared body may also include springs as shown in FIGS. 4a and 4b to provide additional downward force to vessel 120. Another arrangement may involve a sliding closure in combination with vertical actuator 124b.

Display 114 may be provided to convey information to a user of apparatus 100. Display 114 may include a simple LED or LED array configured to illuminate in a particular colour scheme or pattern to indicate when apparatus 100 is in use and/or when disintegration process is complete i.e. the tablet has been disintegrated into the liquid in vessel 120 and is ready for oral consumption. In a more sophisticated embodiment, display 114 may incorporate an LED or LCD screen controlled by control unit 106 to present a user with information such as time remaining until disintegration is complete and control unit 106 may be pre-programmed with personalised medication data, to present a user with information pertaining to relevant dosage regimes, the time and date and other useful information.

Where apparatus 100 is intended for use in the home, control unit 106 may be connected with a remote monitoring station via a local area network (LAN) or wide area network (WAN), telephone line, wireless network or the like. Such connection may be used to communicate compliance information to a remote station as may be located e.g. with a general medical practitioner, nurse or monitoring service, to supervise a user's compliance with prescribed medication regimes.

Apparatus 100 may also be fitted with loudspeaker 130 operated under control of control unit 106 to give audible alerts to a user to indicate when the disintegration process is complete. Loudspeaker 130 may be operable to provide an audible alert to indicate when a medication dosage is due. The audible alert may be in the form of an alarm, beep, chime or synthesised or pre-recorded voice message.

In a preferred embodiment apparatus 100 may also include inputs 132 operable by a user to input data to control unit 106. Inputs 132 may be in a form of buttons, a keypad or a touch-screen incorporated into display 114. Inputs 132 may also include a USB or memory card slot so that control unit 106 may receive personalised medication regime information and/or software and system upgrades.

Cooling unit 128 may be provided to maintain an acceptable temperature within vessel 120. This may be particularly useful where high intensity ultrasonic energy is applied to minimise disintegration time, or where disintegration times are long and cause the contents of vessel 120 to approach a limit of acceptable heating. Cooling unit 128 may also cool apparatus 100 e.g. by way of a fan. Cooling unit 128 may be thermostatically controlled or may operate according to signals from control unit 106.

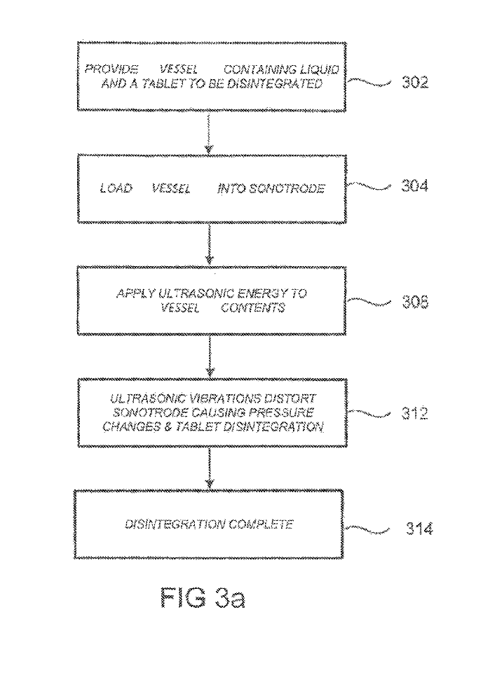

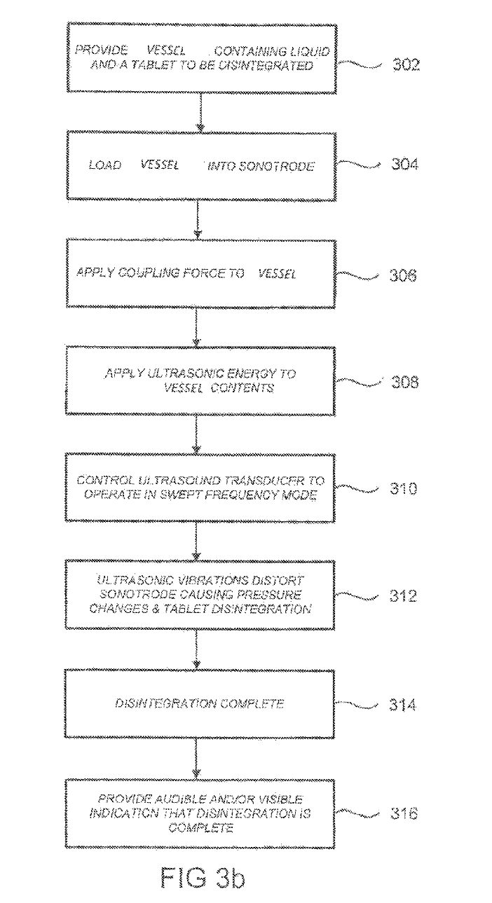

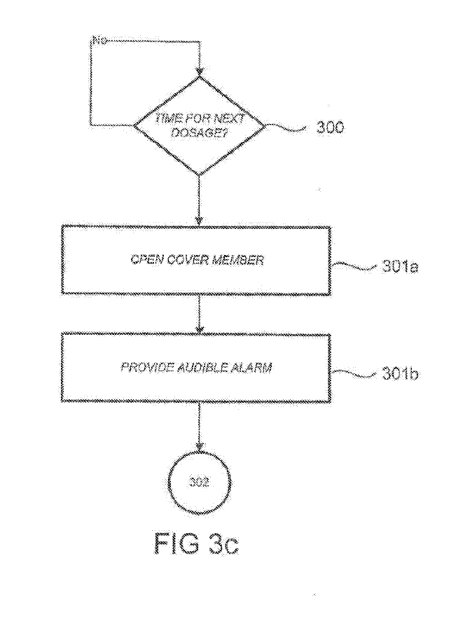

Referring to FIG. 3a, a flowchart illustrates steps in a method of disintegrating a solid medication or pharmaceutical substance in the form of a tablet according to an embodiment of the present invention. In step 302 a drug vessel (120) is provided containing volume of liquid and a tablet to be disintegrated. A volume of around 40 ml is useful for disintegration of most tablet types although initial testing indicates that a larger liquid volume (e.g. 60 ml) may be required as more tablets are placed inside the vessel for disintegration.

More than one tablet may be disintegrated in the drug vessel simultaneously, although this may require higher intensity treatment and/or longer sonication times (and larger liquid volumes as discussed above) to achieve adequate disintegration of the tablets. In step 304 the drug vessel containing the liquid and the tablet is loaded into the sonotrode (112) inside the apparatus and in step 308, ultrasonic energy generated by ultrasound transducer 108 is applied through the wall of the drug vessel to its contents. The ultrasonic vibrations distort the sonotrode causing pressure changes inside the vessel and disintegration of the tablet into particles (step 312). The disintegration process concludes (step 314) when the ultrasound transducer ceases operation.

FIG. 3b is a flow chart illustrating the method of FIG. 3a with additional steps that may be performed in another embodiment of the present invention. Here, in a step 306 a coupling force is applied to the vessel, urging the vessel into the sonotrode to minimise movement during operation thereby maximising ultrasonic energy transference to the contents of the vessel. The coupling force may be about 800 to 1,000 grams downward force and may be applied by a sprung interior membrane of a cover member which covers the vessel when loaded in the apparatus. Preferably, the drug vessel is sealed closed with a removable lid prior to being loaded into the sonotrode. Thus, the coupling force may be applied through the lid and/or through the rim of the opening of the vessel. In a preferred embodiment, control unit 106 may control operation of ultrasound transducer 108 to operate in swept frequency mode (step 310) to minimise likelihood of disintegrated particles grouping together inside the vessel.

TABLE 1

| | Cycle Time | | |
|---|---|---|---|
| Product | 3.5 minutes | 4.5 minutes | 6.5 minutes |
| Diabex Tablet 500 mg | Dispersed | | |
| Losec Tablet 20 mg | Dispersed | | |
| Panadeine Forte Tablet | 50% Dispersed | 60% Dispersed | Dispersed |
| Valium Tablet 5 mg | Dispersed | | |
| Coversyl Plus Tablet | Dispersed | | |
| 5.1.25 mg | | | |
| Maxolon Tablet 10 mg | Dispersed | | |
| Stemetil Tablet 5 mg | Dispersed | | |
| Zocor Tablet 40 mg | 60% Dispersed | Dispersed | |
| Tenormin Tablet 50 mg | Dispersed | | |
| Motilium Tablet 10 mg | Dispersed | | |
| Karvezide Tablet 300/ | 50% Dispersed | 80% Dispersed | Dispersed |
| 12.5 mg | | | |
| Rulide Tablet 150 mg | Dispersed | | |
| Plavix Tablets 75 mg | 60% Dispersed | Dispersed | |
| Panamax Tablets 500 | Dispersed | | |
| mg x 2 | | | |
| Nurofen Caplets 200 mg | Dispersed | | |
| Lipitor Tablet 20 mg | Dispersed | | |

Table 1 above provides results from use of apparatus 100, according to an embodiment of the invention, for disintegration of a variety of solid medications types in a liquid volume of 40 ml. Disintegration and satisfactory dispersion of disintegrated medication within the liquid was achieved in around 3.5 minutes for most medications. All of the medication types tested were disintegrated and dispersed within the liquid in less than 6.5 minutes.

In some embodiments, it may be desirable to use water as the liquid into which the solid is disintegrated and becomes dispersed, dissolved or emulsified. However, many forms of solid medication have a taste which is unpleasant. Accordingly, it may be desirable to use a flavoured liquid as the dispersion medium in order to mask or at least improve the taste of the liquid.

In a particularly preferred embodiment a mechanical agitating mechanism may be employed as shown in FIG. 5 including a paddle coated with a flavouring material. Alternatively, a flavouring powder, liquid or other form of additive may be added to the vessel (120, 53) to mask the unpleasant taste of some medications. Where a flavouring pellet is used, this may be placed in the vessel, along with the solid medication to be disintegrated, prior to sonication. This may ensure that the flavouring pellet is adequately dissolved or dispersed into the liquid, together with the medication.

Ultrasound transducer 108 may be operated under control of control unit 106 which may be pre-programmed to operate transducer 108 for a fixed duration. This duration may be set in firmware according to the type of tablet to be disintegrated. In one embodiment, control unit 106 may be pre-programmed with a range of disintegration times required for disintegration of various tablet types. A user may use inputs 132 to select the tablet type to be disintegrated before loading vessel 120 containing the tablet into sonotrode 112 and closing cover member 116. Control unit 106 may then control ultrasound transducer 108 to deliver ultrasonic energy for a pre-programmed duration required for that tablet.

Alternatively, control unit 106 may determine automatically the time required to disintegrate a tablet in vessel 120. Control unit 106 may also determine automatically an optimal frequency for disintegration of the tablet and optionally, cause transducer 108 to operate in a swept frequency mode.

In a preferred embodiment, apparatus 100 may include one or more optical sensors, accelerometers or the like for detecting the condition of the contents of vessel 120 and specifically, the degree to which the solid has been disintegrated and/or dispersed. The sensors may provide a feedback signal to control unit 106 which in turn may be used to control operation of ultrasound transducer 108. When the sensor signals indicate that the contents of vessel 120 are sufficiently disintegrated (e.g. to a particle size able to be passed through a No. 10 mesh sieve), then control unit 106 may automatically stop operation of ultrasound transducer 108.

Alternatively and/or additionally the sensors may provide a feedback signal to control unit 106 which indicate the extent to which particles in vessel 120 have been mixed. When the sensor signals indicate that the contents of vessel 120 require further mixing (e.g. the suspension is inconsistent) control unit 106 may operate ultrasound transducer 108 in swept frequency mode for further agitation of the contents of vessel 120 and/or may activate a mechanical agitator. When the sensor signals indicate that there has been adequate mixing, control unit 106 may automatically stop operation of ultrasound transducer 108 in swept frequency mode and/or the mechanical agitator and may stop operation of ultrasound transducer 108 altogether.

In a preferred embodiment, when disintegration of the tablet is complete (step 314) control unit 106 may operates loudspeaker 130 to provide an audible alert to a user (step 316) to indicate that the tablet has been disintegrated and is ready for oral consumption by drinking the liquid contents of the vessel. The audible alert may be in the form of an alarm, beep, chime or synthesised or pre-recorded voice message. Alternatively or additionally, control unit 106 may operate display 114 to provide a visible cue at completion of the disintegration process.

In one embodiment, the method steps of FIGS. 3a and 3b may be preceded by the steps of FIG. 3c controlled by control unit 106 which has been pre-programmed with personalised medication data including patient dosage regimes. In this embodiment, control unit 106 may include a clock and may continuously poll to determine whether a medication dosage is due (step 300). If a dosage is due, control unit 106 may actuate cover member 116 to open apparatus 100 in step 301 a and in step 301b may provide an audible alarm through loudspeaker 130 to indicate that medication is due. The user may respond by providing a vessel 120 containing liquid and one or more tablets to be disintegrated (step 302) and may load the vessel 120 into sonotrode 112 (step 304) according to the method of FIG. 3a or 3b.

FIG. 4a shows a side view of a securing device 40 for a vessel 120 that may provide an alternative to cover member 116 and/or force actuator 126 shown in FIG. 1. Vessel securing device 40 includes a flared body 41 adapted to be received in the mouth of vessel 120. The purpose of flared body 41 is to provide better lateral location or alignment for vessel 120 inside housing 102. Approximate location or alignment of vessel 120 may be provided by opening 122 in housing 102.

Vessel securing device 40 includes a plurality of springs 42 - 44 adapted to interface with cover member 116. The purpose of spring 42-44 is to provide additional downward force onto vessel 120 as this may help to ensure good coupling of ultrasonic energy between the floor of vessel 120 and sonotrode 112.

FIGS. 4b and 4c are side and perspective views of a vessel securing device 45 that adds a mechanical agitator 46 to securing device 40 of FIG. 4a. Mechanical agitator 46 comprises a stainless steel hook adapted to agitate or stir dissolved contents in vessel 120. Agitator 46 is driven via direct coupled stepper motor 47 shown inside a hub or pocket of body 41. Agitator 46 may be actuated to more thoroughly disperse or dissolve disintegrated contents such as medication in vessel 120 and/or minimize aggregation of disintegrated contents.

FIG. 5 shows apparatus according to another embodiment of the present invention including a mechanical stirring mechanism. FIG. 5 shows apparatus 50 including ultrasonic receptacle 51, partially filled with water bath 52 and/or another acoustically conductive medium. A drug vessel 53 is placed in water bath 52 with drug tablet(s) 54 placed within drug vessel 53 and water/liquid 55 added to drug vessel 53. Drug vessel 53 may have one or more drug tablets 54 placed in it.

Apparatus 50 includes a vessel securing device having stirrer boss 56 with cover member 57 or similar to help secure and apply downward pressure or force on drug vessel 53 and/or to ensure contact with ultrasonic receptacle 51. Boss 56/ lid 57 may include an over-return spring or a magnetic means (not shown) to apply downward pressure or force. Ultrasonic power may be delivered to receptacle 51 from an ultrasonic transducer (not shown) via waveguide 58. Boss 56 may include a mechanical stirring mechanism including paddle 59. Paddle 59 may be user replaceable.

Referring to FIG. 6, detection of dissolution of drug tablet 54 may be achieved via attenuation of transmitted light, and/or back-scatter, side-scatter or reflection of light. In one form light emitted from optical emitter 61 such as an LED may pass through water/liquid 55 in drug vessel 53 and may scatter (62) when it strikes particles 63 of a dissolved drug tablet 54. The scattered light 62 may be detected by way of detectors 64, 65, 66 respectively.

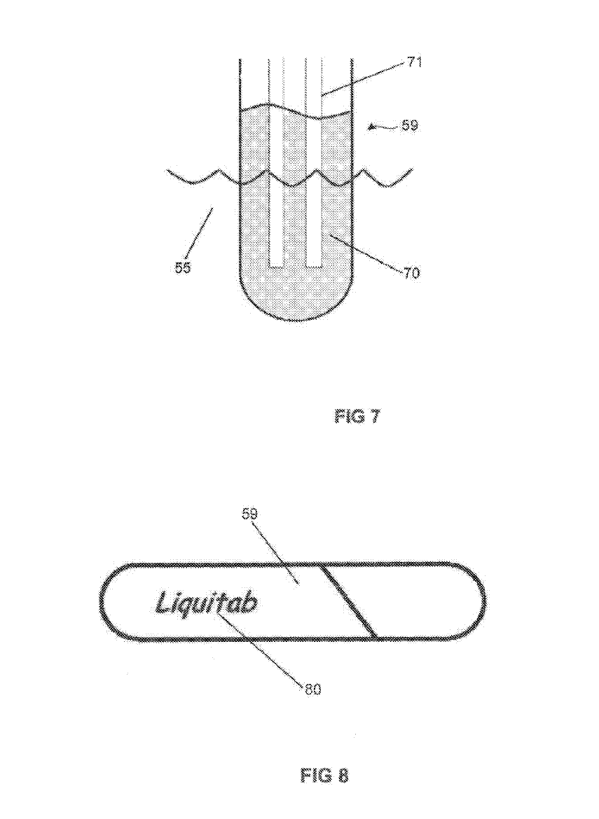

Paddle 59 may include a coating of flavouring material 70 as shown in FIG. 7. Flavouring material 70 may be dissolvable in water/liquid 55 contained in drug vessel 53. Flavouring material 70 may be arranged to have a dissolve time that is commensurate with that of drug tablet 54 that is to be dissolved. Detection of dissolution of paddle coating material 70 may be by optical means and/or electrical conductivity means.

Electrical conductivity means may include two metalized strips 71 placed on the surface of paddle 59 before a coating of flavouring material 70 is applied. This may enable detection of dissolution of flavouring material 70 in water/liquid 55 by utilizing insulating properties of flavouring material 70 to impede electrical conduction. Upon dissolution of flavouring material 70, electrical conductivity between strips 71 will increase due to contact with water/liquid 55 which is more conductive than material 70. The increase in conductivity or reduced resistance between strips 71 may be detected in any suitable manner and by any suitable means known in the art.

Alternatively an optical method may be used to detect dissolution of flavouring material 70 from paddle 59 including by way of fiducial marker 80 as shown in FIG. 8 or similar. Fudicial marker 80 may be visible only when paddle material 70 has been substantially or fully dissolved. Fiducial marker 80 may include but is not limited to a laser etched pattern and/or text.

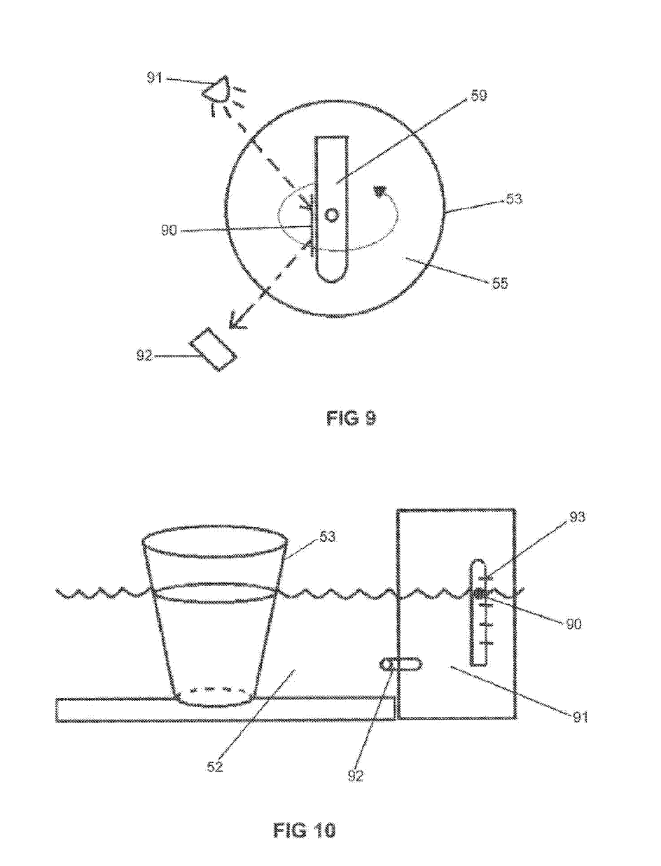

Alternatively fiducial marker 80 may be formed by or may include a highly reflective strip or coating 90 as shown in FIG. 9. Reflective strip or coating 90 may be exposed when paddle coating 70 has been dissolved. Exposure of strip or coating 90 may ensure that paddle 59 is not re-used after flavouring material 70 has been dissolved. In this implementation light emitted from source 91 such as an LED may be reflected from strip or coating 90 and may be detected by optical detector 92 when paddle 59 rotates in water/liquid 55 contained in drug vessel 53.

Flavouring material 70 may be applied to paddle 59 in any suitable manner and by any suitable means. Paddle 59 may be made of plastics, wood and/or another material. Flavouring material 70 may be applied to paddle 59 by a process including spray painting, brush coating, dipping or drying the flavouring material 70 in a mould or by press/forging or otherwise forming flavouring material 70 onto paddle 59.

One method of coating flavouring material 70 onto paddle 59 may include producing a batch of slurry of flavouring material with ingredients including neutral flavoured gelatine, flavouring concentrate such as peppermint essence and/or artificial sweetener. Paddle 59 may be dipped into this slurry of flavouring material and then removed and allowed to dry by natural convection, forced air or heated forced air convection.

Presence of paddle 59 in stirrer boss 56 may be detected in any suitable manner and by any suitable means. The latter may include a micro-switch (not shown) located in boss 56 and/or or by measuring drag applied to an associated drive motor. Drag may be detected by measuring magnitude of current supplied to the drive motor, and/or by detecting a break in an optical beam as it momentarily passes, not unlike the arrangement shown in FIG. 9 for detecting dissolution of flavouring coating material 70.

The level of water bath 52 used to couple ultrasonic energy into drug vessel 53 may be regulated in any suitable manner or by any suitable means. Referring to FIG. 10 a float valve 90 or a larger external reservoir 91 may be employed. If the volume of reservoir 91 is sufficiently large then the effect on level of water bath 52 by placement of drug vessel 53 in ultrasonic receptacle 51 may be minimised. Also a reduction of level of water bath 52 from natural or induced vaporisation may be reduced by presence of a greater volume of water in reservoir 91. Level of water bath 52 may be maintained at a substantially constant level by way of tube 92 and may be viewed by way of indicator 93.

Vessel 120/53 containing a tablet may be loaded into apparatus 100/50 manually. Alternatively, apparatus 100/50 may be fully automated, automatically loading vessel 120/53 into the sonotrode 112/ receptacle 51 and filling with the required volume of liquid. The apparatus may additionally be fitted with a secure container holding tablets or other medication units to be loaded into vessel 120/53 automatically e.g. according to a personalised medication regime pre-programmed into control unit 106, or upon receiving input from a user via inputs 132.

In one embodiment, apparatus 100/50 may be suitable for use in the home, e.g. on a kitchen or bathroom bench. Apparatus 100/50 may be powered from a mains power outlet or it may be embodied in a mobile unit operated by battery. A battery powered unit may be suitable for use in environments where mobility is desirable and in such arrangement it is preferred that the battery is rechargeable by connecting apparatus 100/50 to mains power when it is not in use although replaceable or interchangeable, rechargeable batteries may be employed.

Because the disintegration process involves application of ultrasonic energy having known characteristics, tablets may be disintegrated in a controlled and predictable manner. Thus, there may be consistency in the size of the particles which result from the disintegration process. This is typically not the case for mechanical tablet crushing systems which adopt manual force to break up the tablet. The arrangement of the coupling element (sonotrode) or medium and cup vessel or design may also give rise to improved efficiency over existing tablet crushing methods.

It is to be understood that various modifications, additions and/or alterations may be made to the parts previously described without departing from the ambit of the present invention as defined in the claims appended hereto.

1. Apparatus for disintegration of a solid in a vessel containing liquid, the apparatus comprising:
(a) a control unit;
(b) an ultrasound transducer for generating ultrasonic energy under control of the control unit;
(c) a coupling medium in communication with the ultrasound transducer and adapted to receive the vessel and through which ultrasonic energy is transferred to the contents of the vessel such that in use the ultrasonic energy causes disintegration of the solid into the liquid contained in the vessel; and
(d) an agitating mechanism adapted to agitate the disintegrated solid in the liquid contained in the vessel.

2. Apparatus according to claim 1 wherein said agitating mechanism further comprises a paddle having a coating of a flavouring material.

3. Apparatus according to claim 2 wherein the coating material further comprises neutral gelatine, flavouring concentrate and/or artificial sweetener.

4. Apparatus according to claim 1, comprising a cover member for closing an opening in the vessel, wherein said cover member comprises said agitating mechanism.

5. Apparatus according to claim 4 wherein said cover member comprises a force actuator adapted to apply a force to the vessel to enhance coupling between the vessel and the coupling medium.

6. Apparatus according to claim 4 wherein the cover member is operable from an open configuration to a closed configuration in two or more stages to maintain alignment with the vessel.

7. Apparatus according to claim 2 further comprising means to detect dissolution of the paddle coating material.

8. Apparatus according to claim 7 wherein the means to detect dissolution of the paddle coating material comprises at least one of an optical means, an electrical conductivity means and a fudicial marker.

9. Apparatus according to claims 2 further comprising means to detect presence of said paddle in said agitating mechanism.

10. Apparatus according to claim 9 wherein said means to detect presence of said paddle comprises at least one of a micro-switch associated with the agitating mechanism, means for monitoring current drawn by an associated drive motor and means for monitoring a break in an optical beam.

11. Apparatus according to claim 1 wherein said coupling medium further comprises a water bath.

12. Apparatus according to claim 1 further comprising means for maintaining a predetermined level of said coupling medium.

13. Apparatus according to claim 1 wherein the control unit controls the ultrasound transducer to operate in a swept frequency mode in which ultrasonic energy frequency fluctuates between a resonant frequency and a first non-resonant frequency and optionally, a second non-resonant frequency.

14. Apparatus according to claim 13 wherein the resonant frequency is substantially 42 kHz and the first and second non-resonant frequencies are substantially ±2 kHz relative to the resonant frequency.

15. Apparatus according to claim 13 wherein the swept frequency mode is one or more of: cyclical; random; and dynamically controlled by the control unit based one or more sensor inputs.

16. Apparatus according to claim 1 further comprising cooling means for maintaining temperature of the apparatus and/or contents of the vessel in an acceptable range during operation of the apparatus.

17. Apparatus according to claim 1, wherein the vessel further comprises a marking to indicate a fill level for a liquid added to the vessel.

18. A method for disintegrating a solid in a vessel comprising the steps of:
(a) providing a volume of liquid together with the solid in the vessel;
(b) providing an ultrasound transducer for generating ultrasonic energy;
(c) loading the vessel containing the solid and liquid into a coupling medium in communication with the ultrasound transducer;
(d) transferring the ultrasonic energy to the contents of the vessel to cause disintegration of the solid into the liquid contained in the vessel; and
(d) agitating the disintegrated solid in the liquid contained in the vessel.

19. A method according to claim 18 wherein the step of agitating is performed by means of a paddle having a coating of a flavouring material.

20. A method according to claim 19 wherein the coating material includes neutral gelatine, flavouring concentrate and/or artificial sweetener.

21. A method according to claim 18 further comprising a step of detecting dissolution of the paddle coating material.

22. A method according to claim 21 wherein the step of detecting dissolution of the paddle coating material is performed by at least one of an optical means, an electrical conductivity means and a fudicial marker.

23. A method according to claim 18 further comprising the step of detecting presence of said paddle in an associated agitating mechanism.

24. A method according to claim 23 wherein the step of detecting presence of the paddle is performed by at least one of a micro-switch associated with the agitating mechanism, monitoring current drawn by an associated drive motor and/or monitoring a break in an optical beam.

25. A method according to claim 18 wherein the coupling medium comprises a water bath.

26. A method according to claim 18 further comprising the step of maintaining a predetermined level of the coupling medium.

27. A method according to claim 20 wherein the ultrasonic energy frequency fluctuates between a resonant frequency and one or more non-resonant frequencies.

28. A method according to claim 27 wherein the resonant frequency is substantially 42 kHz and the non-resonant frequencies are substantially ±2 kHz relative to the resonant frequency.

29. A method according to claim 18 further comprising the step of providing one or more of an audible and a visible cue to indicate that the solid in the vessel has been disintegrated in the liquid.

30. A method according to claim 18 wherein the solid comprises a medical preparation such as a tablet, pill, capsule or caplet and the method includes the step of providing one or more of an audible and a visible cue to indicate that a dosage is due.

31. A method according to claim 18 further comprising the step of activating a cooling unit to cool the contents of the vessel and/or an associated apparatus.
